(19) United States
(12) Patent Application Publication
(10) Pub. No.: US 2009/0025320 A1
(43) Pub. Date: Jan. 29, 2009

(54) Apparatus and method for adjustable door frame assembly

(75) Inventors: Jeffrey P. Wagner, Greenfield, IN (US); Joan Smigel, Avon, OH (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Therm-All, Inc., North Olmstead, OH (US)

(21) Appl. No.: 12/217,562

(22) Filed: Jul. 7, 2008

Related U.S. Application Data
(60) Provisional application No. 60/958,483, filed on Jul. 6, 2007.

(51) Int. Cl. E06B 1/52; F16B 35/06; E04B 1/35

(52) U.S. Cl. 52/217; 411/393; 52/745.15

(57) ABSTRACT

An adjustable door frame system includes at least one vertical frame member having a movable vertical subjamb assembly capable of outward movement relative the vertical frame member. The adjustable door frame system also contains a horizontal frame member having a movable horizontal subjamb assembly capable of outward movement relative the horizontal frame member. The door frame system also contains a plurality of adjusting mechanisms coupling the vertical subjamb assembly and horizontal subjamb assembly to the frame members. Each adjusting mechanism includes a hex nut connected to its subjamb assembly with a hex nut clip, and a hollow set screw and guide tube. Rotation of the hollow set screw causes the hex nut to move axially along the guide tube thereby causing the hex nut clip and its connected subjamb assembly to be adjusted outwardly with respect to the door frame system, thereby filling a gap between its frame member and the wall section. After each adjustment mechanism is adjusted as desired, a threaded masonry anchor is inserted through the guide tube, the hollow set screw and the hex nut and into the wall section to fasten the door frame system to the wall section.

### CROSS REFERENCE TO RELATED APPLICATION

This application claims the priority benefit of U.S. Provisional Patent Application Ser. No. 60/958,483 filed Jul. 6, 2007.

### BACKGROUND OF THE INVENTION

1. Field of Invention

This invention relates to the use of a pre-assembled metal frame door system for installation into an existing building opening where the walls are made of rigid material such as concrete.

2. Description of Related Art

Concrete openings offer a challenge for installing door systems because it is difficult to precisely control the size of the opening such that a pre-assembled door system can be installed quickly without the use of shims. Two generally common methods are used to create an opening in a concrete wall. One method is to position a form slightly larger than the door frame within a larger wall form as the concrete is poured to create the wall section. The void created by the door form creates the required opening once the form is removed. The second method is to cut an opening in a solid wall with a masonry saw or similar device. Often these openings are ½″ to 1½″ larger than the door frame and may have a variation from a straight line of up to ½″. In order for most doors to operate correctly, workers must fill the gaps between the opening and the door frame with shims. This process can be tedious and requires skilled workers.

### SUMMARY OF THE INVENTION

The invention is directed to a system and method of installing a pre-assembled metal door system into an opening in a rigid wall section. A door system is provided that allows a worker to position the door into the opening, adjust the width of the adjustable door frame to match the profile of the opening, adjust frame for square, and then securely fasten the door system in the opening. The system and method are configured for installing door systems in openings in which the mounting surfaces are not true and square. Desirably, the apparatus and method allows for the removal and replacement of the door system if required.

In one sense, the invention is directed to an adjustable door frame system for use in an opening in a rigid wall section. The minimum dimensions of the adjustable door frame system are slightly smaller than the dimensions of the opening in the wall section. The adjustable door frame system includes at least one vertical frame member having a movable vertical subjamb assembly capable of outward and inward movement relative the vertical frame member, and wherein the vertical frame member contains at least one dimpled hole therein. The adjustable door frame system also contains a horizontal frame member having a movable horizontal subjamb assembly capable of outward and inward movement relative the horizontal frame member, and wherein the horizontal frame member contains at least one dimpled hole therein. The door frame system also contains a plurality of adjusting mechanisms, each adjusting mechanism aligned with one of the dimpled holes in horizontal and vertical frame members and coupling each vertical subjamb assembly and horizontal subjamb assembly to its respective frame member. Each adjusting mechanism includes a hex nut connected to its subjamb assembly with a hex nut clip, and a hollow set screw and guide tube.

Rotation of the hollow set screw in a first direction causes the hex nut to move axially along the guide tube thereby causing the hex nut clip and its connected subjamb assembly to be adjusted outwardly with respect to the door frame system, thereby filling a gap between its frame member and the wall section. The vertical and horizontal subjamb assemblies are moved outwardly from the frame system by the adjusting mechanisms so as to enable the door frame system to expand and obtain a precise fit within the opening of the wall section. After each adjustment mechanism is adjusted as desired, a threaded masonry anchor is inserted through the dimpled hole, the guide tube, the hollow set screw and the hex nut and into the wall section to fasten the door frame system to the wall section.

In another sense, the invention is directed to a method of installing the adjustable door frame system in the opening in the rigid wall section. The method includes placing the adjustable door frame system in the opening of the wall section such that there is a vertical gap between a vertical frame member of the door frame system and the wall section, and a horizontal gap between a horizontal frame member of the door frame system and the wall section. Then a horizontal subjamb assembly is moved outward from its horizontal frame member by inserting a key into a first guide tube and first hollow set screw and rotating the set screw so as to move a first hex nut connected to the horizontal subjamb assembly. Rotation of the first hollow set screw in a first direction causes the first hex nut to move axially along the first guide tube thereby causing the horizontal subjamb assembly to be adjusted outwardly with respect to the door frame system thereby filling the horizontal gap between horizontal frame member and the wall section. A vertical subjamb assembly is also moved outward from its vertical frame member by inserting the key into a second guide tube and second hollow set screw and rotating the set screw so as to move a second hex nut connected to the vertical subjamb assembly. Rotation of the second hollow set screw in a first direction causes the second hex nut to move axially along the second guide tube thereby causing the vertical subjamb assembly to be adjusted outwardly with respect to the door frame system thereby filling the vertical gap between vertical frame member and the wall section. Masonry anchors may then be inserted through the first and second guide tubes, hex nuts and hollow set screws and into the wall section to fasten the door frame system to the wall section.

These and other features and advantages of this invention are described in, or are apparent from, the following detailed description of various exemplary embodiments of the systems and methods according to this invention.

### BRIEF DESCRIPTION OF THE DRAWINGS

The structure, operation, and advantages of the presently disclosed embodiment of the invention will become apparent when consideration of the following description taken in conjunction with the accompanying drawings wherein:

FIG. 1 illustrates a side elevation view of an adjustable door frame system within a partial wall section, with a breakout view indicating internal components of the system;

FIG. 2 illustrates a detail view (A) of the breakout view indicated in FIG. 1;

FIG. 3 illustrates a partial perspective view as shown in FIG. 1, less the partial wall section, including a breakout view indicating internal components of the system;

FIG. 4 illustrates a detail view (B) of the partial perspective breakout view shown in FIG. 3;

FIG. 5 illustrates a perspective view of a vertical subjamb assembly;

FIG. 6 illustrates a detail view (C) of the perspective view of the vertical subjamb assembly in FIG. 5;

FIG. 7 illustrates a detail view (D) of the perspective view of the vertical subjamb assembly in FIG. 5;

FIG. 8 illustrates a perspective view of a horizontal subjamb assembly;

FIG. 9 illustrates a detail view (E) of the perspective view of the horizontal subjamb assembly in FIG. 8;

FIG. 10 illustrates a partial cross-sectional view of the adjustable door frame system with the cut orientation centrally positioned at a threaded adjuster, where the system is shown in a fully retracted position;

FIG. 11 illustrates a partial perspective cross-sectional view of the adjustable door frame system with the cut orientation positioned at a threaded adjuster, where the system is shown partially expanded with an adjusting tool in position;

FIG. 12 illustrates a partial perspective cross-sectional view of the adjustable door frame assembly with the cut orientation positioned at a threaded adjuster, where the system is shown partially expanded with a drill bit positioned through the threaded adjuster;

FIG. 13 illustrates a partial perspective cross-sectional view of the adjustable frame assembly with the cut orientation positioned at a threaded adjuster, where the system is shown partially expanded with a fastener positioned through the frame system and into the wall section; and

FIG. 14 illustrates a partial cross-sectional view of the adjustable frame assembly with the cut orientation centrally positioned at a threaded adjuster, where the system is shown in an expanded position secured with a fastener.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

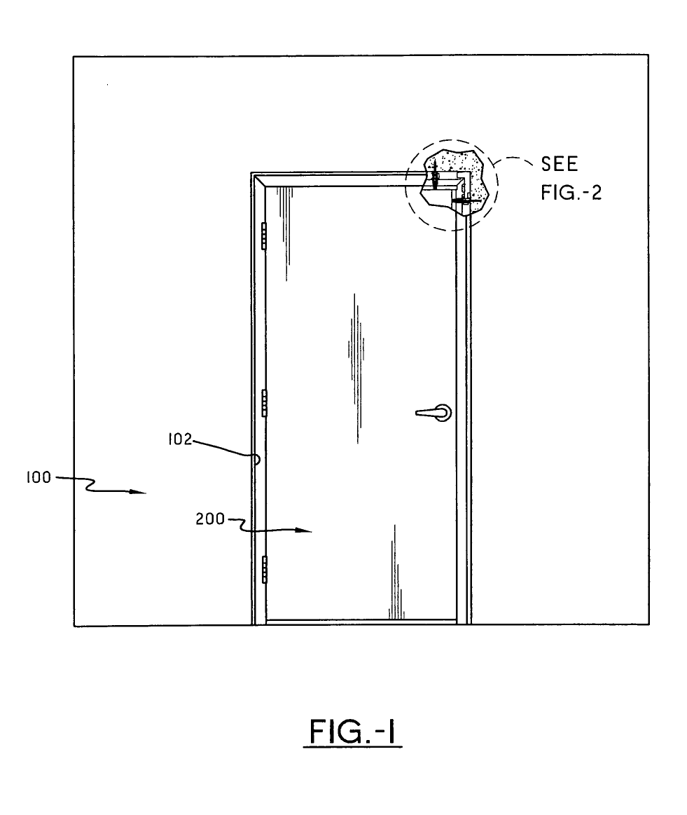

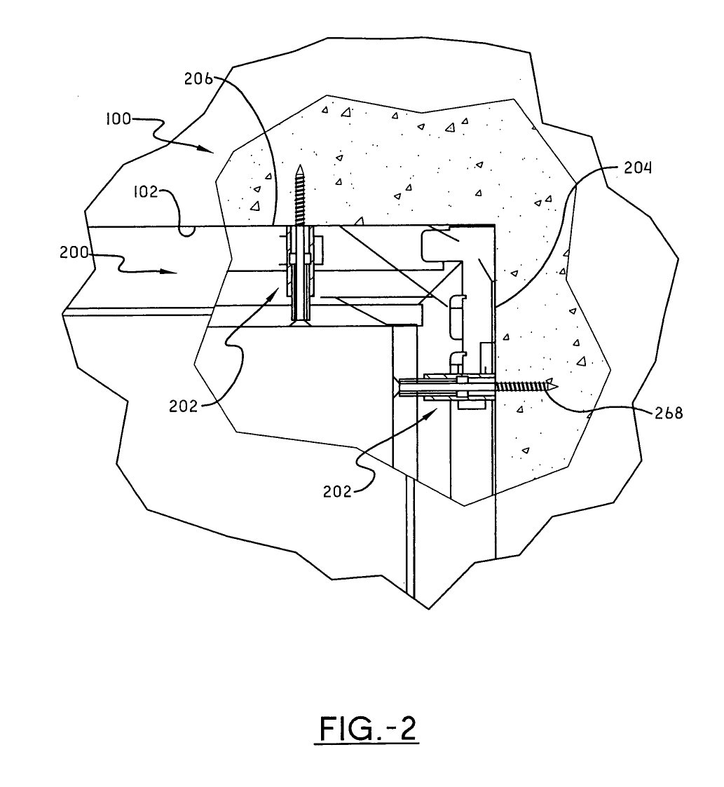

FIG. 1 shows a rigid wall section 100 having an adjustable door frame system 200 positioned therein. As can be seen, an opening 102 in the wall section 100 is configured to receive the adjustable door frame system 200. To aid in installation, the opening 102 in the wall section 100 is slightly larger than the minimum dimensions of the adjustable door frame system 200. This is typical of masonry construction for door installation, as it is less difficult to fill the excess gap between the door frame system 200 and the surrounding wall section 100 than to remove small amounts of the wall section 100 to create an exact fit. Additionally, a wider opening 102 allows for adjustment in installing the door frame system 200 in a vertically plum condition. According to the invention, the door frame system 200 has a number of adjusting mechanisms 202 that enable the door frame system 200 to expand and form a precise fit in the opening 102 of the wall section 100. Turning now to the enlarged cutaway view of FIG. 2, the adjustable door frame system 200 has vertical subjamb assemblies 204 and a horizontal subjamb assembly 206. The vertical subjamb assemblies 204 and horizontal subjamb assembly 206 are moved outwardly from the frame system 200 with the adjusting mechanisms 202 to obtain a precise fit of the door frame system 200 within the wall section 100 as will be explained in detail below.

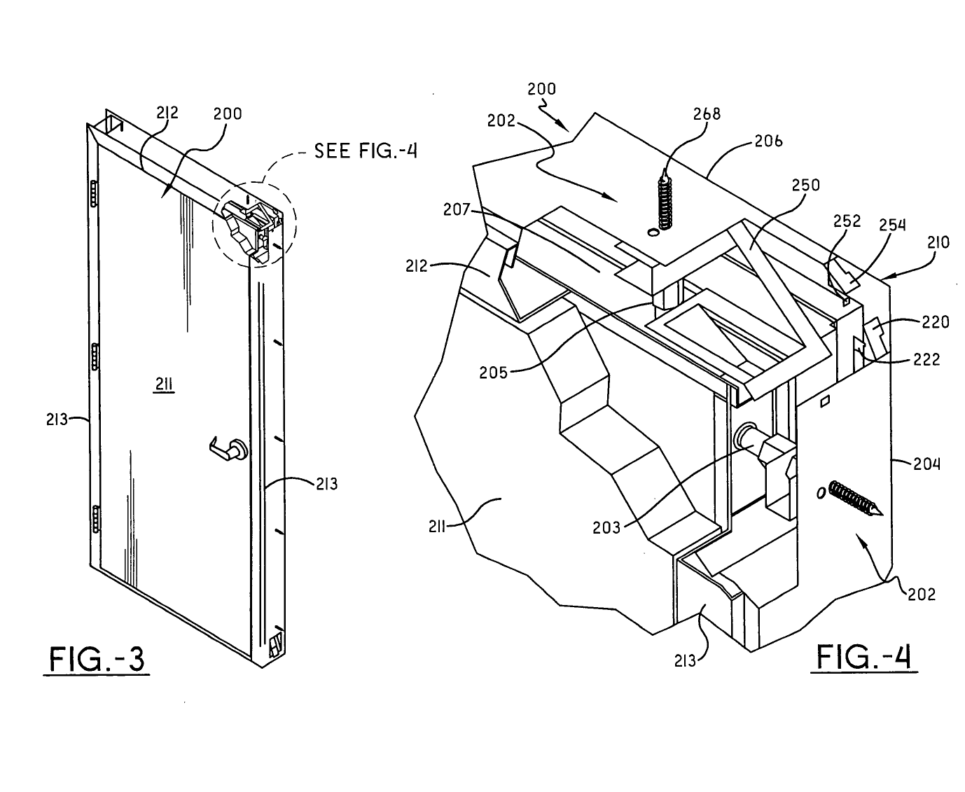

As best seen in the perspective view of FIG. 3 and the enlarged cutaway view of FIG. 4, the adjustable door frame system 200 contains a door leaf 211 mounted within a horizontal frame member 212 and vertical frame members 213. The horizontal frame member 212 is generally referred to as a header frame and the vertical frame members 213 are often referred to as either a hinge frame or strike frame. To facilitate the adjustability function of the invention, vertical subjamb assembly 204 for the vertical frame members 213 and horizontal subjamb assembly 206 for the horizontal frame member 212 are designed in such a manner to move outwardly relative the frame system 200 and engage the wall section 100. In one embodiment of the invention, the expanded adjustment is about 0.75 inches (1.9 cm) on each of the horizontal and vertical frame members 212, 213. This would allow for about 1.5 inches (308 cm) of horizontal adjustment and 0.75 inches (1.8 cm) of vertical adjustment between the adjustable door frame system 200 and the surrounding wall section 100. However, one skilled in the art will recognize that the adjustable door frame system 200 may be designed with different capacities for adjustment without departing from the scope of the invention. The relative capacity for adjustment is generally limited to the width of the frame members 212, 213. Therefore, wider frame members 212, 213 allow for increased adjustment capacity.

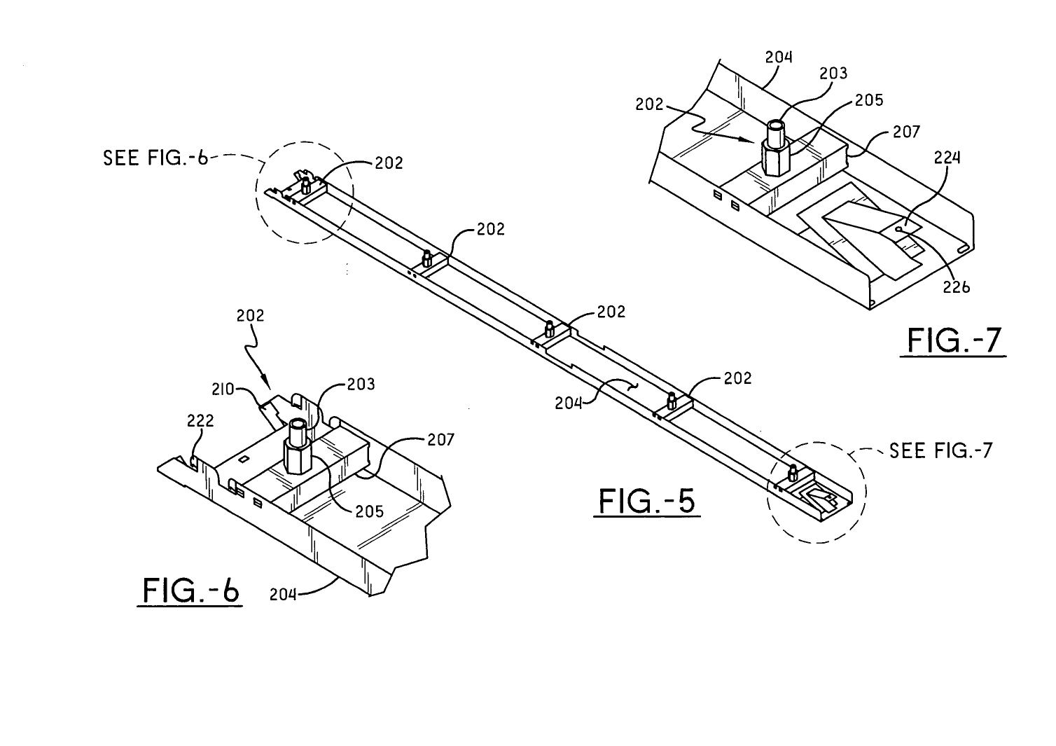

FIG. 5 illustrates a multiplicity of adjustment mechanisms 202 forming a multiplicity of adjustment points along the vertical subjamb assembly 204. FIG. 5 also allows for points of reference for the enlarged detail views of FIGS. 6 and 7. FIG. 6 shows an enlarged detail view of one adjustment mechanism 202 near the upper-most end of the vertical subjamb assembly 204. The upper most end of vertical subjamb assembly 204 contains tabs 220 and tabs 222. Tabs 220 and tabs 222 maintain position of corner filler plates 210 shown in FIG. 4 against the vertical subjamb assembly 204. Additionally, tabs 222 aid in extending corner filler plate 210 as vertical subjamb 204 is expanded. Corner filler plates 210 are used in each of the four corners to fill any gaps created as the vertical subjamb assemblies 204 and horizontal subjamb assembly 206 are biased outwardly.

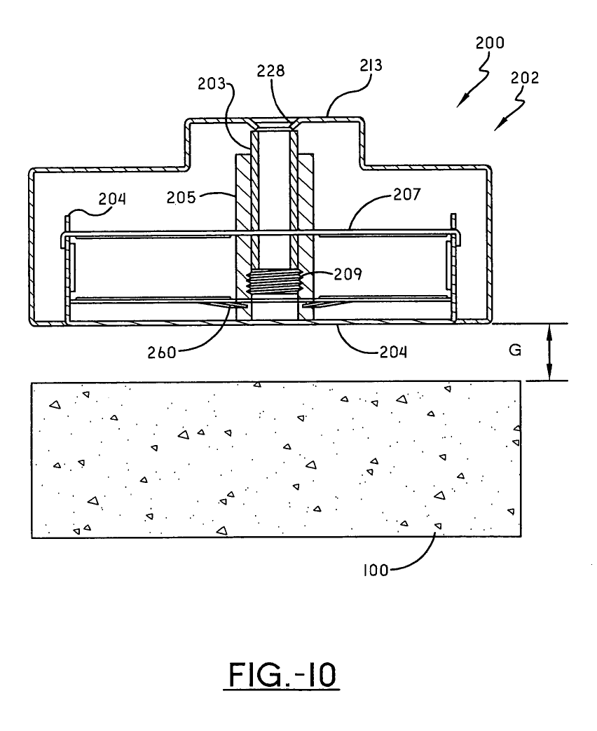

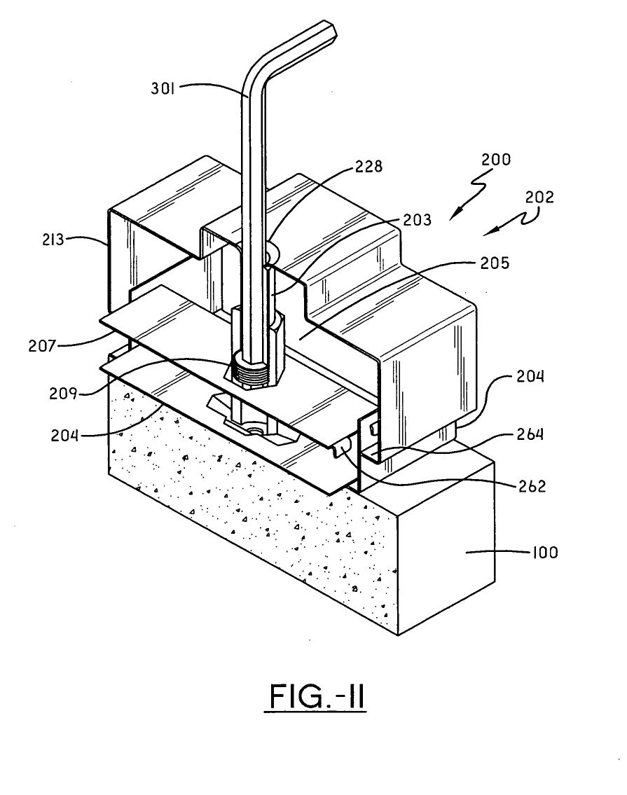

FIG. 7 represents the lower-most end of vertical subjamb assembly 204. The lower-most end of vertical subjamb assembly 204 contains flexible tab 224. Tab 224 contains a hole 226 used to secure the vertical subjamb assembly 204 to the vertical frame member 213 via the use of a fastener (not shown). It is desirable that vertical subjamb assembly 204 maintains relative alignment within the vertical frame member 213 such that dimpled holes 228 (best seen in FIG. 10) in the vertical frame member 213 are in axial alignment with guide tubes 203 and hollow set screws 209. Flexible tab 224 is designed such that it enables sufficient outward movement of the vertical subjamb assembly 204 but limits vertical movement of vertical subjamb assembly 204 with respect to the vertical frame member 213.

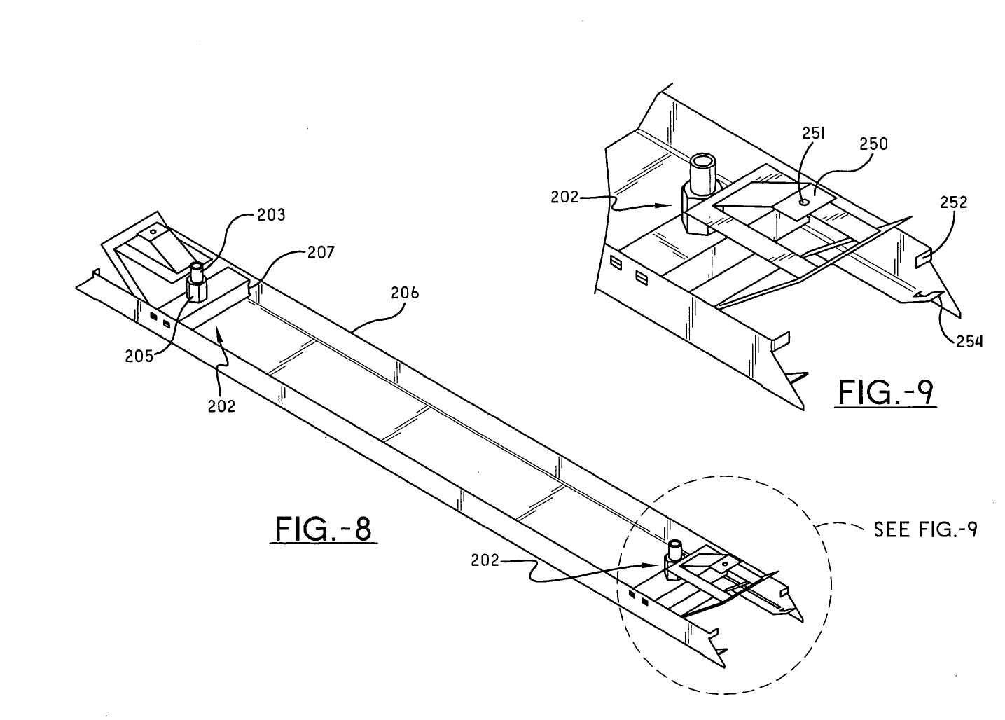

The horizontal subjamb assembly 206 shown in FIG. 8 illustrates a multiplicity of adjustment mechanisms 202 forming a multiplicity of adjustment points along the horizontal subjamb assembly 206. FIG. 8 also allows for points of reference for the detail view shown in FIG. 9. Flexible tab 250 shown in FIG. 9 is designed such that it enables sufficient outward movement of the subjamb assembly 206 relative the horizontal frame member 212 but limits horizontal relative movement, thereby maintaining relative axial alignment of the dimpled holes 228 in horizontal frame member 212, the guide tubes 203 and the hollow set screws 209. Opposite ends of horizontal subjamb assembly 206 each utilize flexible tabs 250 which contain holes 251 in which fasteners (not shown) are used to secure the horizontal subjamb assembly 206 to the horizontal frame member 212. FIG. 9 indicates tabs 254 and tabs 220 (seen in FIG. 6) are used to maintain the corner filler plate 210 against horizontal subjamb assembly 206. Tab 252 aids in extending corner filler plate 210 as adjustment mechanisms 202 are expanded along the horizontal subjamb 206.

FIGS. 10-14 show sectional views of a representative adjustment mechanism 202. These figures illustrate an adjustment mechanism 202 in one vertical frame member 213, however, it is to be understood that it is representative of adjustment mechanisms 202 in either the vertical frame members 213 or the horizontal frame member 212. For an outward adjustment to fill a gap G between the frame member 213 and the wall section 100, a hollow hex set screw 209 is turned from its initial position and in a manner that allows a hex nut 205 to move toward the wall section 100. Hex nut 205 is forced outwardly because the inner most surface of hollow set screw 209 maintains its relative position with the guide tube 203 such that the hex nut 205 moves axially along the guide tube 203. Hex nut 205 is positioned within a hex nut clip 207 and secured thereto by a friction fit of tabs 260. Vertical subjamb assembly 204 is pushed outwardly within frame member 213 as hex nut 205 and hex nut clip 207 are adjusted outwardly due to the rotation of the hollow set screw 209, thereby filling gap G between the subjamb assembly 204 and the wall section 100.

FIG. 11 shows a hex key 301 inserted through the dimpled hole 228 in the frame member 213, guide tube 203 and hollow set screw 209. Also indicated are tabs 262 which are used to secure the hex nut clip 207 to the subjamb assembly 204. An additional function of tabs 262 is to limit outward movement of the subjamb assembly 204. Maximum outward adjustment is limited when contact is made between the tabs 262 on the hex nut clip 207 and surface 264 of frame member 213.

Each hollow set screw 209 is adjusted such that the subjambs 204, 206 of the door frame system 200 expand tightly within the opening 102 of the wall section 100. Subjamb assemblies 204, 206 are somewhat flexible allowing conformity to non-planar surfaces of the wall opening 102. The door frame system 200 is then checked for plumb and level. Additional adjustments of hollow set screws 209 may be necessary.

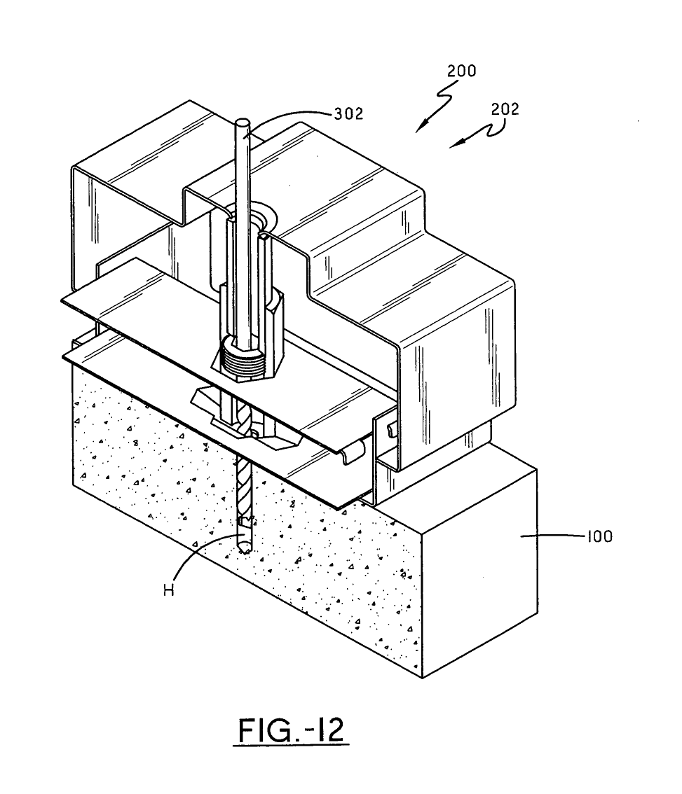

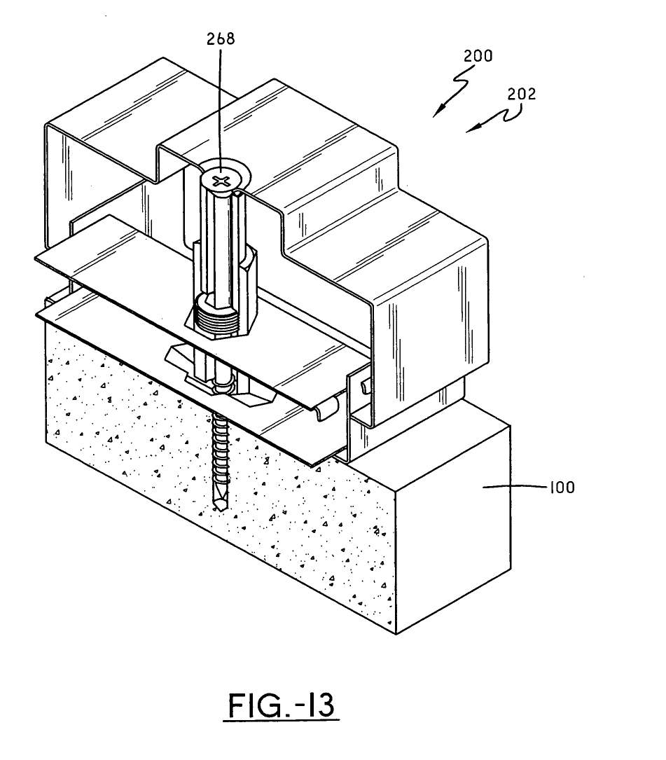

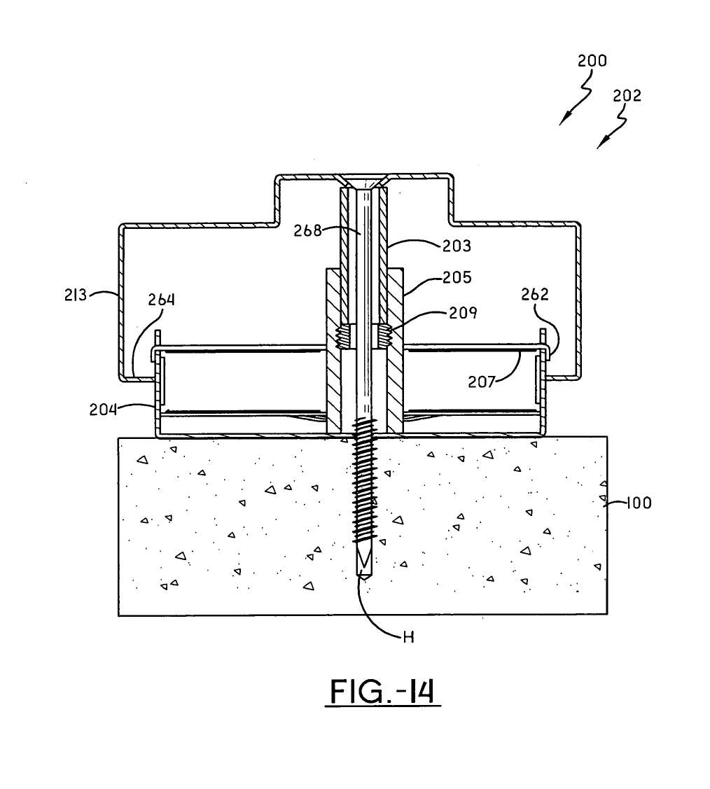

After each hollow set screw 209 is adjusted properly and the door frame system 200 is adequately level and plumb, a masonry drill bit 302 is used to drill a hole H in the wall section 100 as shown in FIG. 12. A threaded masonry anchor 268 is then used to securely fasten the door frame system 200 to wall section 100 as shown in FIGS. 13 and 14.

After installation is complete, it is sometimes desirable to remove the door frame system 200 from the wall section 100 due to damage or other need. This is easily accomplished by removing all of the threaded masonry anchors 268 and then adjusting each of the hollow set screws 209 inwardly. The door frame system 200 can then be removed and replaced if needed.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention.

What is claimed is:

1. An adjustable door frame system for use in an opening in a rigid wall section, wherein the minimum dimensions of the adjustable door frame system are slightly smaller than the dimensions of the opening in the wall section, the adjustable door frame system comprising:
at least one vertical frame member having a movable vertical subjamb assembly capable of outward and inward movement relative the vertical frame member;
a horizontal frame member having a movable horizontal subjamb assembly capable of outward and inward movement relative the horizontal frame member; and
a plurality of adjusting mechanisms coupling the vertical subjamb assembly and horizontal subjamb assembly to their respective frame members, wherein the at least one vertical subjamb assembly and horizontal subjamb assembly are moved outwardly from the frame system by the adjusting mechanisms so as to enable the door frame system to expand and obtain a precise fit within the opening of the wall section.

2. The door frame system of claim 1 wherein each adjusting mechanism comprises a hex nut connected to its subjamb assembly with a hex nut clip, and a hollow set screw and guide tube, wherein rotation of the hollow set screw in a first direction causes the hex nut to move axially along the guide tube thereby causing the hex nut clip and its connected subjamb assembly to be adjusted outwardly, thereby filling a gap between its frame member and the wall section.

3. The door frame system of claim 2 wherein a lower-most end of the vertical subjamb assembly contains a flexible tab used to secure the vertical subjamb assembly to the vertical frame member such that the vertical subjamb assembly maintains relative vertical alignment with the vertical frame member such at least one dimpled hole in the vertical frame member is in axial alignment with the guide tube and hollow set screw of an adjusting mechanism.

4. The door frame system of claim 2 wherein the hex nut is secured within the hex nut clip by a friction fit.

5. The door frame system of claim 2 wherein the hex nut clip is secured to its subjamb assembly with tabs, and wherein the tabs further limit the outward movement of the subjamb assembly when contact is made between the tabs and a surface of its frame member.

6. The door frame system of claim 2 wherein after each hollow set screw is adjusted as desired, a threaded masonry anchor is inserted through the guide tube, hollow set screw and hex nut and into the wall section to securely fasten the door frame system to the wall section.

7. The door frame system of claim 1 further comprising a plurality of corner filler plates, wherein a corner plate is used in each of the four corners to fill any gap created as the vertical subjamb assembly and horizontal subjamb assembly are biased outwardly.

8. An adjustable door frame system for use in an opening of a rigid concrete wall section, wherein the minimum dimensions of the adjustable door frame system are slightly smaller than the dimensions of the opening in the wall section, the adjustable door frame system comprising:
at least one vertical frame member having a movable vertical subjamb assembly capable of outward and inward movement relative the vertical frame member, and wherein the vertical frame member contains at least one dimpled hole therein;
a horizontal frame member having a movable horizontal subjamb assembly capable of outward and inward movement relative the horizontal frame member, and wherein the horizontal frame member contains at least one dimpled hole therein; and
a plurality of adjusting mechanisms, each adjusting mechanism aligned with one of the dimpled holes in horizontal and vertical frame members and coupling each vertical subjamb assembly and horizontal subjamb assembly to its respective frame member, wherein each adjusting mechanism comprises a hex nut connected to its subjamb assembly with a hex nut clip, and a hollow set screw and guide tube, wherein rotation of the hollow set screw in a first direction causes the hex nut to move axially along the guide tube thereby causing the hex nut clip and its connected subjamb assembly to be adjusted outwardly with respect to the door frame system, thereby filling a gap between its frame member and the wall section, wherein the at least one vertical subjamb assembly and horizontal subjamb assembly are moved outwardly from the frame system by the adjusting mechanisms so as to enable the door frame system to expand and obtain a precise fit within the opening of the wall section; and
a plurality of threaded masonry anchors, wherein after each adjustment mechanism is adjusted as desired, a threaded masonry anchor is inserted through one of the dimpled holes, the guide tube, the hollow set screw and the hex nut of each adjustment mechanism and into the wall section to fasten the door frame system to the wall section.

9. The door frame system of claim 8 wherein a lower-most end of the vertical subjamb assembly contains a flexible tab used to secure the vertical subjamb assembly to the vertical frame member such that the vertical subjamb assembly maintains relative vertical alignment with the vertical frame member.

10. The door frame system of claim 8 wherein the hex nut is secured within the hex nut clip by a friction fit.

11. The door frame system of claim 8 wherein the hex nut clip is secured to its subjamb assembly with tabs, and wherein the tabs further limit the outward movement of the subjamb assembly when contact is made between the tabs and a surface of its frame member.

12. A method of installing an adjustable door frame system in an opening of a rigid concrete wall section, wherein the minimum dimensions of the adjustable door frame system are slightly smaller than the dimensions of the opening in the wall section, the method comprising:
placing the adjustable door frame system in the opening of the wall section such that there is a vertical gap between a vertical frame member of the door frame system and the wall section, and a horizontal gap between a horizontal frame member of the door frame system and the wall section;
moving a horizontal subjamb assembly outward from its horizontal frame member by inserting a key into a first guide tube and first hollow set screw and rotating the set screw so as to move a first hex nut connected to the horizontal subjamb assembly, wherein rotation of the first hollow set screw in a first direction causes the first hex nut to move axially along the first guide tube thereby causing the horizontal subjamb assembly to be adjusted outwardly with respect to the door frame system, thereby filling the horizontal gap between horizontal frame member and the wall section;
moving a vertical subjamb assembly outward from its vertical frame member by inserting the key into a second guide tube and second hollow set screw and rotating the set screw so as to move a second hex nut connected to the vertical subjamb assembly, wherein rotation of the second hollow set screw in a first direction causes the second hex nut to move axially along the second guide tube thereby causing the vertical subjamb assembly to be adjusted outwardly with respect to the door frame system, thereby filling the vertical gap between vertical frame member and the wall section; and
inserting masonry anchors through the first and second guide tubes, hex nuts and hollow set screws and into the wall section to fasten the door frame system to the wall section.

13. The method of claim 12 further comprising drilling holes in the wall section using a drill bit that is inserted through the first and second guide tubes, hex nuts and hollow set screws and into the wall section to provide holes for the masonry anchors.
